(19) United States
(12) Patent Application Publication
(10) Pub. No.: US 2007/0150802 A1
(43) Pub. Date: Jun. 28, 2007

(54) DOCUMENT ANNOTATION AND INTERFACE

(75) Inventors: Ernest Yiu Cheong Wan, Carlingford, New South Wales (AU); Eileen Oi-Yan Mak, Cherrybrook, New South Wales (AU); Jeroen Vendrig, Liberty Grove, New South Wales (AU); Myriam Elisa Lucie Amielh, Ryde, New South Wales (AU); Joshua Brendon Worrill, Newtown, New South Wales (AU)

Correspondence Address: FITZPATRICK CELLA HARPER & SCINTO, 30 ROCKEFELLER PLAZA, NEW YORK, NY, 10112, US

(73) Assignee: Canon Information Systems Research Australia Pty. Ltd., North Ryde (AU)

(21) Appl. No.: 11/562,567

(22) Filed: Nov. 22, 2006

(30) Foreign Application Priority Data
Dec. 12, 2005 (AU) 2005242219
Dec. 12, 2005 (AU) 2005242224

(51) Int. Cl. G06F 17/00; G06F 7/00

(52) U.S. Cl. 715/512; 707/104.1; 707/100

(57) ABSTRACT

A method for use in annotating documents provided in a collection. The method comprises determining, an annotation gain for a number of document clusters, the annotation gain being at least partially indicative of the effect of annotating at least one document associated with the respective cluster. A recommendation can then be determined using the determined annotation gains, the recommendation being indicative of at least one cluster. An indication of the recommendation can then be provided.

### FIELD OF THE INVENTION

The present invention relates to a method and apparatus for use in annotating documents provided in a collection, and in particular to a method and apparatus for determining a recommendation of a next cluster to be annotated next to maximise improvement in annotation coverage. The present invention also relates to a method and apparatus for use in presenting an interface for use in annotating documents.

### DESCRIPTION OF THE BACKGROUND ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Document collections are growing quickly in the digital age. For example, the advent of Digital Cameras has made the creation of personal libraries of photographs considerably easier by allowing consumers to view, edit, select and process digital images without being dependent on a photo development service. As a result, users of digital cameras frequently generate and store large collections of personal digital images.

Conversely, the growing volume of document collections makes it harder to find and to use the documents. For example, in personal photo libraries it is uneasy and time-consuming for users to assemble images into albums, slideshows, diaries or calendars, to search for specific images, and to browse through image databases. It is therefore highly desirable to provide methods of organising and accessing sizeable collections of documents.

Using document analysis to automatically generate useful metadata has been tried with limited success. The analysis problem is especially hard when the modality of the documents, for example visual for an image, does not correspond to the modality of the annotations, for example textual for a key word. Therefore, manually entered metadata remains the more effective way to make document collections easily searchable. For that reason, reducing the annotation workload is crucial when collecting user's annotations.

Supervised and semi-supervised learning is an alternative approach for facilitating annotation of multimedia content. An active annotation system can include an active learning component that prompts the user to label a small set of selected example content that allows the labels to be propagated with given confidence levels. Supervised learning approaches require a substantial amount of input data before proving effectiveness. Although it is possible to restrict the annotation vocabulary to learn conceptual models faster, this tends to make the annotation system less appealing.

Moreover, users of digital cameras and personal computers are generally not enthusiastic to spend time making notes on their content. Annotating content is usually regarded as a tedious task that users tend to avoid despite of the benefit. Consequently, a user's initial interest and effort are usually limited and it is therefore important to make use of the user's input as efficiently as possible.

A pro-active approach to annotation consists of automatically partitioning a collection of documents into clusters sharing enough semantic information. User Annotations can then be physically or virtually propagated through document clusters. Thus, it becomes possible to make use of the annotation effort on a cluster basis instead of individual documents. Documents can be grouped from various aspects. For instance, images can be grouped based on the event to which they relate, the people they contain, or the location of the scene. Various methods of time-based and/or content-based partitioning have been developed for the purpose of grouping images according to a particular aspect.

Another approach for making the annotation process easier is the use of summaries. When requesting User's annotations, groups of documents may be summarised, for example because their sizes are not suitable for a particular Graphical User Interface. For example, several approaches for summarising collections of images have been developed in particular for the purpose of video. For example, some methods automatically select a small number of key-images by computing the percentage of skin-coloured pixels in the image or by estimating the amount of motion activity.

However, conventional annotation systems follow an approach where presentation of documents and clusters does not focus on making use of limited user efforts efficiently. For example, they show clusters ordered temporally. If this is used in assigning annotations, this assumes that the temporal order of the photos defines their relative importance, such that for example, photos of the first or last day of a holiday would be deemed more relevant than photos half way the holiday. As a result, the user ends up either annotating documents that are not necessarily the most relevant, or browsing through the clusters so as to find the relevant clusters. In both cases the required user effort makes it not very attractive for users to annotate a collection.

In addition, conventional systems assume that any annotation is equally valuable. This is often not the case. For example, if a thousand images are annotated with the same value, the annotations are of limited use in applications such as retrieval and browsing. There is not much point in having the user annotate a thousand and first photo with the same annotation.

Furthermore, these applications generally view annotation as a secondary feature and consequently documents are not displayed on screen in a manner that is optimised for the collection of annotation, but rather in a layout that is more conducive to browsing or editing documents. This means that in order to annotate documents that are not grouped together the user must make complex selections of individual items with the mouse.

Consequently conventional annotation systems do not provide the user with needed direction and they fail to make the process of annotating attractive and worthwhile to users.

### SUMMARY OF THE PRESENT INVENTION

It is an object of the present invention to substantially overcome, or at least ameliorate, one or more disadvantages of existing arrangements.

In a first broad form the present invention provides a method for use in annotating documents provided in a collection, the method comprising, in a processing system:
a) determining, for a number of document clusters, an annotation gain, the annotation gain being at least partially indicative of the effect of annotating at least one document associated with the respective cluster;
b) determining a recommendation indicative of at least one cluster in accordance with the determined annotation gains; and,
c) providing an indication of the recommendation.

In a second broad form the present invention provides apparatus for use in annotating documents provided in a collection, the apparatus including a processing system for:
a) determining, for a number of document clusters, an annotation gain, the annotation gain being at least partially indicative of the effect of annotating at least one document associated with the respective cluster;
b) determining a recommendation indicative of at least one cluster in accordance with the determined annotation gains; and,
c) providing an indication of the recommendation.

In a third broad form the present invention provides a computer program product for use in annotating documents provided in a collection, the computer program product being formed from computer executable code, which when executed on a suitable processing system is for:
a) determining, for a number of document clusters, an annotation gain, the annotation gain being at least partially indicative of the effect of annotating at least one document associated with the respective cluster;
b) determining a recommendation indicative of at least one cluster in accordance with the determined annotation gains; and,
c) providing an indication of the recommendation.

In a fourth broad form the present invention provides a method for use in annotating documents provided in a collection, the method comprising, presenting an interface on a display using a processing system, the interface comprising:
a) at least one cluster representation indicative of a cluster of documents within the collection; and,
b) at least one indicator indicative of at least one of:
   i) an annotation level associated with the at least one cluster;
   ii) a recommendation of annotations to be performed; and,
   iii) a confidence score indicative of the confidence in the annotations applied to documents in the cluster.

In a fifth broad form the present invention provides apparatus for use in annotating documents provided in a collection, the apparatus comprising a processing system and a display, the processing system being for presenting an interface on the display, the interface comprising:
a) at least one cluster representation indicative of a cluster of documents within the collection; and,
b) at least one indicator indicative of at least one of:
   i) an annotation level associated with the at least one cluster;
   ii) a recommendation of annotations to be performed; and,
   iii) a confidence score indicative of the confidence in the annotations applied to documents in the cluster.

In a sixth broad form the present invention provides a computer program product for use in annotating documents provided in a collection, the computer program product being formed from computer executable code, which when executed on a suitable processing system causes the processing system to present an interface on a display, the interface comprising:
a) at least one cluster representation indicative of a cluster of documents within the collection; and,
b) at least one indicator indicative of at least one of:
i) an annotation level associated with the at least one cluster;
ii) a recommendation of annotations to be performed; and,
iii) a confidence score indicative of the confidence in the annotations applied to documents in the cluster.

### BRIEF DESCRIPTION OF THE DRAWINGS

An example of the present invention will now be described with reference to the accompanying drawings, in which:

FIG. 1 is a flow chart of an example of a process of recommending documents for annotation;

FIG. 2 is a schematic diagram of an example of a processing system;

FIGS. 3A to 3C are a flow chart of a specific example of a process of selecting documents for annotation;

FIG. 4 is a graph of an example of an effectiveness function;

FIG. 5 is a flow chart of a specific example of a process for determining an annotation coverage;

FIG. 6 is a schematic diagram of a number of documents;

FIGS. 7A and 7B are schematic diagrams of an example of a graphical user interface for presenting documents for annotation;

FIG. 8 is a flow chart of a specific example of a process for assessing user interest in documents;

FIGS. 9A to 9C are a flow chart of a specific example of a process of presenting documents for annotation; and,

FIG. 10 is a schematic diagram of an example of a Graphical User Interface for providing annotations.

### DETAILED DESCRIPTION INCLUDING BEST MODE

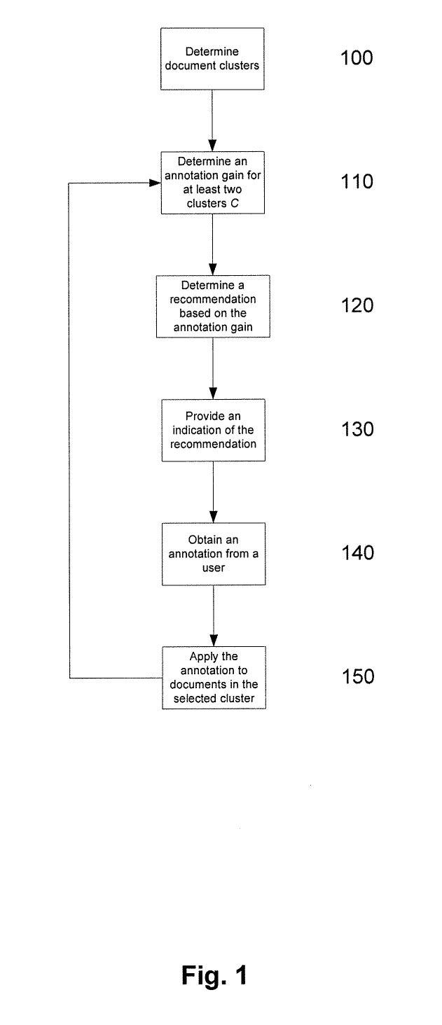

An example of the process for determining an annotation recommendation will now be described with reference to FIG. 1.

At step 100 a number of document clusters are determined. The document clusters may be determined in any one of a number of ways and may for example be defined manually by a user, predefined, or automatically assigned by a processing system as will be described in more detail below.

At step 110 an annotation gain is determined for at least two clusters C. The annotation gain is a value that is at least partially indicative of the improvement in annotation coverage that will be provided if some or all of the documents within the cluster are annotated.

At step 120 the annotation gain is used to determine a recommendation as to which one or more clusters C should be annotated, with this being provided to a user at step 130.

The provision of a recommendation in this manner then optionally allows the user to select a cluster and provide an annotation at step 140. It will be appreciated that in this regard the user does not need to select the same cluster as recommended although in general this will be preferred. If an annotation is provided, then at step 150 the annotation is applied to one or more selected documents in the cluster with the process returning to step 110 to determine annotation gains for each cluster.

The documents within clusters generally share certain relationships or characteristics. As a result, the above described process uses the annotation gain for each cluster to estimate the benefit for the user in annotating the documents within the corresponding cluster. This can take into account the user's interest and the ease of using the data in the future, thereby helping the user to focus on clusters and documents which are best annotated first.

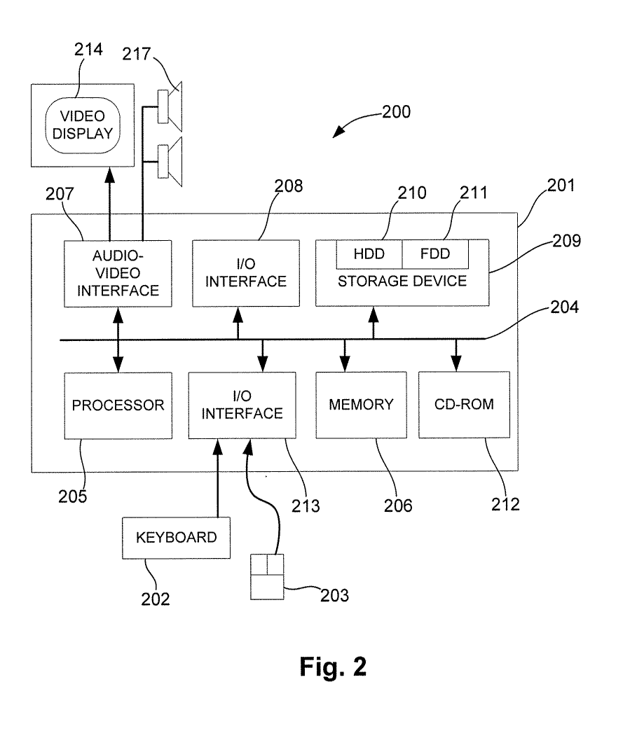

In general, the process is performed via a human-computer interface presented on a general-purpose computer system, to allow documents and/or clusters to be viewed, a recommendation to be provided, and annotations to be collected. An example of a suitable general-purpose computer system is shown in FIG. 2.

The computer system 200 is formed by a computer module 201, input devices such as a keyboard 202 and mouse 203, and output devices including a printer 215, a display device 214 and loudspeakers 217.

The computer module 201 typically includes at least one processor unit 205, and a memory unit 206, formed for example from semiconductor random access memory (RAM) and read only memory (ROM). The module 201 also includes an number of input/output (I/O) interfaces including an audio-video interface 207 that couples to the video display 214 and loudspeakers 217, and an I/O interface 213 for the keyboard 202 and mouse 203 and optionally a joystick (not illustrated). An I/O interface 208, such as a network interface card (NIC) is also typically used for connecting to the computer to a network (not shown), and/or one or more peripheral devices.

A storage device 209 is provided and typically includes a hard disk drive 210 and a floppy disk drive 211. A magnetic tape drive (not illustrated) may also be used. A CD-ROM drive 212 is typically provided as a non-volatile source of data.

The components 205 to 213 of the computer module 201, typically communicate via an interconnected bus 204 and in a manner that results in a conventional mode of operation of the computer system 200 known to those in the relevant art. Examples of computers on which the described arrangements can be practised include IBM-PC's and compatibles, Sun Sparcstations or the like.

The processes of clustering documents, calculating annotation gains, providing annotation recommendations and annotating documents is typically implemented using software, such as one or more application programs executing within the computer system 200. Typically, the application programs generate a GUI (Graphical User Interface) on the video display 214 of the computer system 200 which displays documents, clusters, annotations, or recommendations.

In particular, the methods and processes are affected by instructions in the software that are carried out by the computer. The instructions may be formed as one or more code modules, each for performing one or more particular tasks. The software may be stored in a computer readable medium, and loaded into the computer, from the computer readable medium, to allow execution. A computer readable medium having such software or computer program recorded on it is a computer program product. The use of the computer program product in the computer preferably affects an advantageous apparatus for annotating clusters of documents.

The term “computer readable medium” as used herein refers to any storage or transmission medium that participates in providing instructions and/or data to the computer system 200 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 201. Examples of transmission media include radio or infra-red transmission channels as well as a network connection to another computer or networked device, and the Internet or Intranets including e-mail transmissions and information recorded on Websites and the like.

Clustering

The term cluster refers to one or more documents selected from the collection of documents or parts thereof according to a particular relationship criterion or to certain characteristics.

Clusters may be generated automatically by a clustering algorithm executed by the computer system 200, created manually by a user, or formed through a combination of automated or manually processes.

In the event that clustering is performed automatically by the computer system 200, the computer system 200 typically executes a predetermined clustering algorithm stored in memory. This can operate to cluster documents using a range of factors, such as a similarity between documents in the collection, a temporal interval between documents in the collection, a spatial interval between documents in the collection, user interactions with the documents, a document quality and fuzzy logic rules.

Thus, in one example, a collection of text documents can be partitioned according to their creation dates, according to their authors or according to the proper nouns used in the document. Alternatively, a collection of digital images may be partitioned according to the distribution of their time stamps, the event they are associated with, the location they are related to, the people they show, their capture parameters, or the lighting conditions.

In one example, the clustering process produces a hierarchy of clusters where a parent cluster is further partitioned into one or more sub-clusters, wherein each additional level of the hierarchy adds a new set of criteria on the relationship/characteristics of the documents. Such clustering may as well produce overlapping clusters with shared documents.

Thus, for example, a clustering process based on elapsed time between images can produce a number of image clusters forming a first level of hierarchy. Each cluster can be further-divided into clusters of high-similarity images, based on some image analysis results. In this case, the first level of hierarchy represents a temporal relationship, while the second level of hierarchy can be interpreted as representing a location relationship.

Cluster Summaries

When a computer system is used to annotate clusters, it is typically to display the clusters to the user on the display 214, using a GUI. However, in some case the GUI bears graphical limitations meaning it is impractical to display all of the documents within a cluster. Consequently, the computer system 200 typically presents cluster summaries, indicative of the documents in the cluster.

Thus, for example, in the case of digital images, such summaries might include, but are not limited to, montages such as mosaics of images, or sets of selected images. The goal of a summary is to convey the characteristics that are common to the documents in the cluster so that the user can have an idea of the content of the cluster without going through all documents.

In one example, cluster summaries formed from at least one image that is most representative of the cluster to minimize the risk of assigning an irrelevant annotation to other images in the cluster. The optimal number of representative images is estimated through the number of sub-clusters that can be extracted by performing further sub-clustering using more stringent criteria on image similarities.

The sub-clusters produced are typically ordered according to their size, and the N largest sub-groups are selected where N is the number of most representative images required by the annotation system. For each selected sub-group, images are ranked according to the features they share with other images of said sub-group, their quality, and a measure of the level of user interest on the image. Then, a most representative image is selected based on the ranking.

Annotation

The term annotation refers to voice records, keywords, comments, notes or any type of descriptive metadata that can be attached to a document by a user. It will be clear to anyone skilled in the art that the invention can easily be extended to any type of multimedia documents without departing from the scope of the invention. For instance, in an alternative embodiment this technique can also be applied to text, audio and video documents, CAD designs of buildings and molecules or models of DNA sequences.

An annotation may comprise one or more category-value pairs, e.g. category=“location”—value=“France”. In the example, the description focuses on measures making use of a category-value pair in an annotation. However, computations may equally apply to the use of multiple category-value pairs of an annotation.

In general, an annotation is applied to and associated with a document. If an annotation is applied to or associated with a document that already has an annotation, the category-value pairs of both annotations can be merged into one annotation.

In one example, documents are annotated by having the computer system 200 acquire annotations from the user. A request may be done actively, that is requesting an annotation for a specific cluster, or passively, that is allowing the user the opportunity to annotate any of the clusters.

The timing of requesting annotations depends on the application workflow. For example, annotations may be requested when uploading photos from a camera to the computer. In another example, the user may be prompted when browsing documents. The user may even be requested to provide annotation when waiting for another process to be completed.

In one example, all clusters are ordered and presented according to their annotation gain. In an alternative embodiment, only those clusters with the highest annotation gain are presented, say the top 3, or the clusters with an annotation gain exceeding a predetermined threshold, say 0.8.

Propagation

Typically, annotations are assigned to all documents in the cluster being annotated. In this example, when the user annotates a cluster summary, the annotation is applied to all documents of the cluster for which the summary was produced. Hence, the annotation may be applied to a document that the user did not see or inspect while providing the annotation.

In one example, annotations are classified into two types. Annotations are treated as the explicit type when they are entered by the user and as the implicit type when they are propagated from other documents. Accordingly, if a cluster summary is presented to the user, the annotation is explicit for those documents that were visible in the summary, while the annotation is implicit for those documents that are not visible in the summary.

In one example, annotations can be applied by duplication. In another example, annotations are applied by referencing. User annotations and their references can be stored separately from the collection or internally. For instance, in the case of digital images, at least a portion of user annotations or references may be stored as metadata, such as EXIF (Exchangeable Image File format) data of the individual images. EXIF is a standard for storing metadata in image files, comprising many predefined data fields as well as custom fields.

The advantage of duplicating annotations is that the annotation can be used independently of the annotation system. For example, a user may e-mail an image with a duplicated annotation in the EXIF data to a friend. The friend may be able to use the annotation of the image, even though he does not have the annotation system and any separately stored annotation. The advantage of storing a reference is that related annotations may be tracked and that changes to annotations, such as the correction of a spelling mistake can be propagated more easily.

An indicator may be kept to indicate whether an annotation is of the explicit type or of the implicit type. For example, an indicator may be used in the EXIF data of an image to record the type of annotation. Instead of or in addition to an indicator, a confidence score may be used. The confidence score may be computed from a number of factors, including the annotation type (such as an annotation category), the similarity between documents that have an explicit annotation and documents that have an implicit annotation, and user exposure to the documents. Information at least partially indicative of the confidence score, such as the values that serve as input for computing a confidence score, may be stored in addition to or instead of the confidence score. For example, the confidence score may be computed from the RGB histogram intersections of images and/or from the proximity of the creation time stamps. In another example, the confidence score may be computed as the number of photos in a cluster summary presented divided by the total number of photos in the cluster. In this case, the first level of hierarchy represents a temporal relationship, while the second level of hierarchy can be interpreted as representing a location relationship.

Recommendation

The present system can operate to improve the efficiency of user annotations by providing a recommendation indicator, such as a recommendation icon, indicative of the next one or more clusters to be annotated. This is determined to encourage the user to apply annotations to clusters for which the annotation is expected to improve the utility of the annotations in the collection. Such recommendation is computed based on the annotation gain 110.

Annotation Gain

The annotation gain is used to help the user focus on which clusters and documents are best annotated first. In one example, this can be determined by the computer system 200 based on a user interest aspect and/or a system aspect.

The user interest aspect is concerned with ensuring that the clusters and documents being annotated are relevant to the user. The system aspect is concerned with improving annotation coverage of the collection, i.e. improving the accessibility of documents through applications that may make use of the annotations, such as a retrieval system, a browsing system or a summary system. This allows the annotation process to balance user annotation effort and the utility of the annotations.

Accordingly, the user is typically encouraged to apply annotations to clusters for which annotation is expected to improve the utility of the annotations in the collection. For example, if many photos in the collection have the very general annotation “event=holiday”, it is considered beneficial to have the user annotate a cluster that has an annotation different from “event=holiday” such as “event=birthday”, or a sub-cluster in which the photos have characteristics in common in addition to “event=holiday”, e.g. “event=visit to Lake Tekapo”.

The process works particularly well as an interactive system, in which the annotation gain is computed iteratively. The system can then make optimal use of the annotation impact measure (to be described later) on which the annotation gain is based. The user may enter several annotations for several clusters in one session, or the user may continue annotating in more than one session, or several users may contribute annotations in several sessions, with the annotation gain being recomputed when the annotation of one or more documents in the collection have changed. This can occur, for example because the user adds or removes a category-value pair, or because a third party has provided a duplicate of a document in the collection with annotations associated by the third party.

The annotation gain may also be recomputed when user interest for one or more documents in the collection has changed, for example because of editing or browsing of the documents. The annotation gain may also be recomputed following a change in configuration of the clusters, such as when one or more clusters have changed or been recomputed, for example to add, remove or combine clusters. Similarly, the annotation gain may be recomputed when cluster membership is changed, such as when documents are added to or removed from clusters, or moved from one cluster to another cluster. The annotation gain can also be recomputed when documents are added to or removed from the collection.

### Specific Example

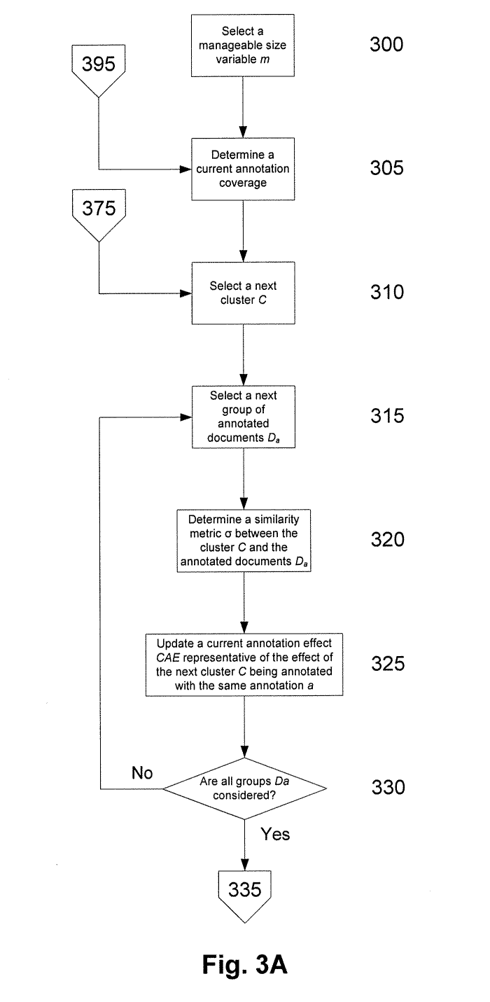

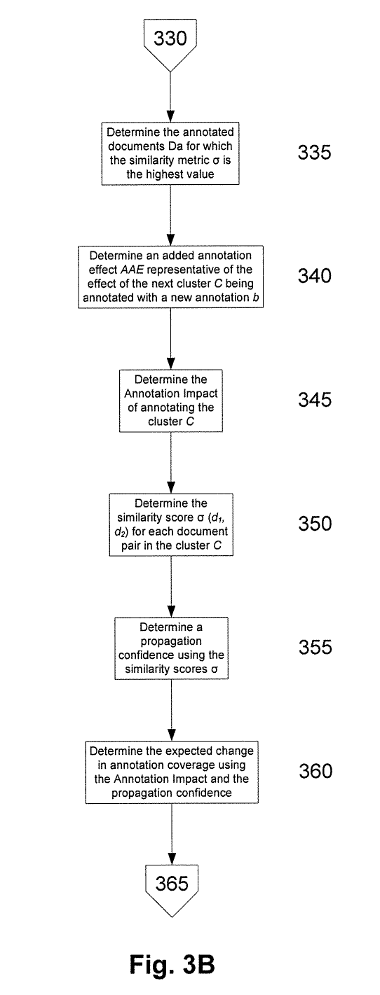

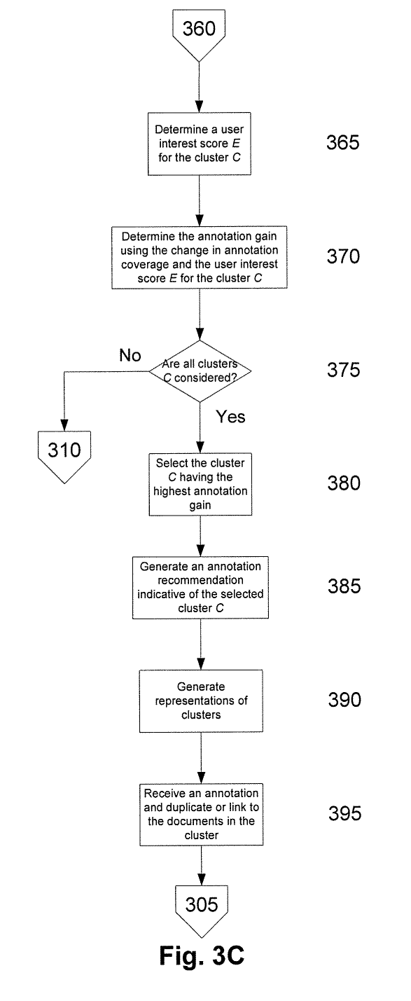

A specific example of the process for determining an annotation recommendation using the computer system 200 will now be described with more detail with respect to FIGS. 3A to 3C.

At step 300 a manageable size variable m is selected. The manageable size variable m is selected to represent a manageable number of documents for annotation. This is used to measure the effectiveness of an annotation, with the annotation being more effective the closer the number of documents that share an annotation is to m.

The manageable number will depend on the context in which the annotations are to be used. Consequently, the value of m may be a factory setting, say 12 documents or 10% of the total number of documents in the collection, or it may be set by a user or the computer system, depending on factors such as the number of documents that can be displayed on a GUI, a number of documents that may be printed on a piece of paper, the resolution of the computer system display 214, or the like.

At step 305 an annotation coverage is determined. The annotation coverage typically depends on two or more of the following:
the extent to which documents are annotated,
the discriminative power of the annotations,
the effectiveness of the annotations, and
the efficiency of the annotations.

Each of the four components of annotation coverage (extent, discriminative power, effectiveness, efficiency) will now be described.

For the purpose of this description, it is assumed that the documents are annotated with category-value pairs, in which a specific value is assigned to a respective category. Thus, for example, the category may be event, with the assigned value being holiday, thereby providing a category-value pair a of “event=holiday”.

For this example, D is the total collection of documents. Let the || operator compute the number of documents in a collection, cluster or group of documents, for example: |D| is the number of documents in the total collection. Let Dₐ be a category-value pair, and let A_{d} be the set of all category-value pairs associated with document d. Let A_{D} be the set of all category-value pairs found in the collection. Let Da be the set of all documents that have category-value pair a.

The extent measures what fraction of documents have an annotation with at least one category-value pair. In one example, the computer system 200 determines this using the following equation:

$$extent ( D ) = \frac{{\sum }_{d ∈ D} min ( 1 , \vert {A}_{d} \vert )}{\vert D \vert} \qquad ( 1 )$$

The discriminative power measures an annotation's ability in separating clusters. The discriminative power for a category-value pair a is found in the collection can be determined by the computer system 200 as follows:

$$disc\_pow ( a , D ) = \frac{1}{\vert {D}_{a} \vert} \qquad ( 2 )$$

A retrieval system or a browser may query a collection of documents for documents that contain a certain annotation a. If the number of documents returned is too large, for example spanning more result pages than a user would be willing to sift through, the annotation is considered to have a relatively low effectiveness for accessing documents. If there is no annotation for which a document is accessible effectively, there is a need for new annotations to make that document accessible in an effective way.

What is considered effective depends on the context in which the annotations are used or applied, for example, depending on the client applications software using the annotations. Although specific requirements and limitations of client applications are not known, assumptions about the general requirements of such applications can be made. For example, it is not effective for annotations to be shared by more photos than can be presented on a screen or printed on one page. Usability tests may determine what number of documents can share an annotation in an effective way, for example measuring how many images can be presented on a screen legibly.

In one example, the effectiveness measures if the number of documents with the same category-value pair a has a manageable size m. It is determined by the computer system 200 as follows:

$$effectiveness ( a , D ) = \{ \begin{matrix}{( \frac{m}{\vert {D}_{a} \vert} )}^{- q} & if {D}_{a} \leq \vert m \vert \\ {( \frac{m}{\vert {D}_{a} \vert} )}^{k} & if \vert {D}_{a} \vert > m\end{matrix} \qquad ( 3 )$$

In this example, q is a constant greater than or equal to 0, which is used for controlling the rate at which effectiveness increases when there are less than m documents associated with category-value pair a. q is usually set to a value smaller than or equal to 1, and in one example, q is set to 0.001, so that more emphasis is placed on the number of documents being manageable.

Factor k is a constant greater than or equal to 1, for controlling the rate at which effectiveness decreases once Dₐ's size is greater than m and in one example is set to 2.

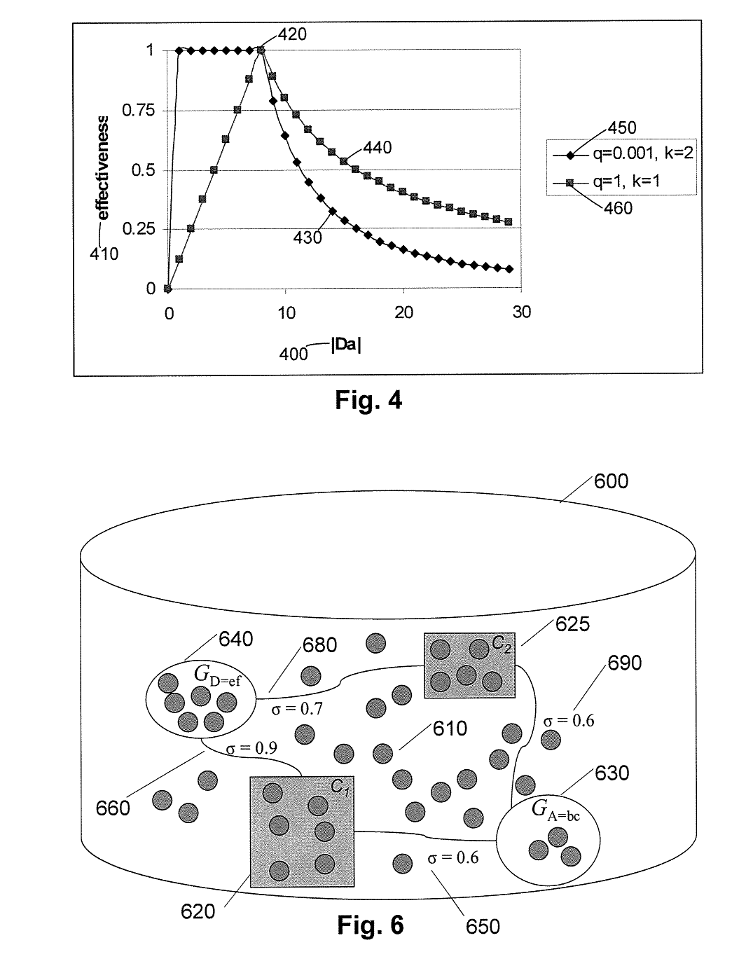

An example of effectiveness measurements is shown in FIG. 4. In this example, the number of documents with annotation a (|Dₐ|) 400 is plotted against the effectiveness 410. In the example, m is set to 8 corresponding to the peak in the graphs 420. in this example, first graph 430 uses settings for q=0.001 and k=2, as shown at 450. Second graph 440 uses alternative settings q=1 and k=1, as shown at 460.

The efficiency component measures whether annotations have been added without waste. In this example, the efficiency measures whether a document is annotated with the minimal number of category-value pairs. It is computed as follows:

$$efficiency ( D ) = \{ \begin{matrix}0 & if \vert {A}_{D} \vert = 0 \\ \frac{{\sum }_{d ∈ D , \vert {A}_{d} \vert > 0} {\vert {A}_{d} \vert}^{- s}}{{\sum }_{d ∈ D} min ( 1 , \vert {A}_{d} \vert )} & otherwise\end{matrix} \qquad ( 4 )$$

where s is a predefined constant greater than 0, and usually smaller than or equal to 1, which is used for controlling the rate at which efficiency decreases for annotating a document with more than one category-value pair. In one example s is set to 2.

Annotation coverage can be defined using two or more of the four components extent, discriminative power, effectiveness and efficiency, in different ways giving different emphasis to different components in accordance with the requirements of the applications.

In this example, annotation coverage is defined as follows:

$$AnnotationCoverage ( D ) = \frac{{\sum }_{d ∈ D , \vert {A}_{d} \vert > 0} {max}_{a ∈ {A}_{d}} ( effectiveness ( a , D ) )}{\vert D \vert} \cdot efficiency ( D ) \qquad ( 5 )$$

Here the extent is represented by the sum over all documents and the division by the size of the collection. By integrating the components, redundancy of terms is avoided. As the effectiveness and efficiency measures used in this example have already taken into account discriminative power and extent respectively, separate terms for discriminative power and extent are not required in this example. The maximum function is applied to select the category-value pair associated with a document that results in the highest effectiveness.

Typically the annotation coverage is 0 when no documents are annotated and 1 when each document is annotated with exactly one category-value pair and for each category-value pair in the collection |Dₐ|=|D|/m, that is: each category-value pair a is associated with exactly m documents.

As it may be hard to define a precise value for m, a distribution based on m may be used instead of m as a single value. The expected effectiveness is then computed as follows:
expected effectiveness(a, D)=Σᵢ₌₁^{|Da|}p(m=i)·effectiveness(a, D|m=i) (6)
where p is the probability that a value i is the maximum manageable size. For example, the probability may be based on a Poisson probability distribution.

The four components of annotation coverage can be combined in a variety of ways without departing from the essence of the current invention.

At step 310 a next cluster C is selected to determine the annotation gain for that respective cluster. The annotation gain can include both system and user aspects, as mentioned above.

The system aspect of annotation gain requires the clusters to be scored to determine which cluster, if it were to be annotated, will result in the greatest improvement in annotation coverage. Predicting the change in annotation coverage is trivial if each added category-value pair is new to the document collection. However, in practice it is more likely that some category-value pairs are reused for several clusters. Therefore, for computing the expected change in annotation coverage, the possibility that an existing category-value pair is reused needs to be taken into account.

This is achieved by calculating an annotation impact that compares the current annotation coverage and the expected annotation coverage after the annotation of the cluster C to be scored. In this example, in computing the expected annotation coverage as a result of annotating a cluster, the collection is not actually annotated with that value. The computation can be seen as running a “what-if” scenario.

In this example, an annotation impact is based on current annotation effect (CAE) and/or added annotation effect (AAE) measures, as follows:
AnnotationImpact(C,D)=CAE(C,D)+AAE(C,D) (7)

The CAE measures the effect of annotating the cluster with a category-value pair already associated with some documents in the collection. The AAE measures the effect of annotating a cluster with a category-value pair that has not already been associated to any document in the collection.

Both CAE and AAE are computed by comparing the documents in cluster C to groups of documents Dₐ assigned a category-value pair a, for all possible category-value pairs.

This allows the annotation impact to be computed based on the correlation between features of the cluster to be scored and the current category-value pairs in the collection, which can be determined using various approaches.

In one example, current category-pairs values are examined against the documents in the cluster. The correlation is then based on the likelihood that a current category-value pair applies to documents in the cluster to be scored. This approach is suitable when it is possible to analyze the content of a document to assess whether an annotation applies to a document. For example, the likelihood may be based on the number of times a previously entered category-value pair occurs in the text documents in the cluster to be scored. In an example of a stolen goods database, the characteristics of an image of art work may be analysed to compute the probability that it belongs to a particular class and style, such as impressionist painting or renaissance sculpture.

However, it is not always possible to assess whether an annotation applies to a document without knowledge about the context of the collection and about the semantics of the annotation. Therefore, in the current example, the likelihood that a previously entered category-value pair a will be applied to the cluster C is computed by comparing certain quantifiable features of documents Dₐ previously annotated with the category-value pair a to documents in cluster C, to determine a level of similarity. For example, two sets of documents may be compared by calculating the highest, lowest or average similarity of pairs of documents.

The CAE uses the similarity between the cluster to be scored and a set Dₐ to determine the likelihood that the cluster to be scored will have category-value pair a. The more similar the two sets are, the more likely it is that the cluster to be scored will be annotated with a.

The AAE uses the similarity between the cluster to be scored and the one Dₐ set that is most similar to the cluster to be scored to determine the likelihood that a novel category-value pair will be used. If the cluster to be scored is not similar to any of the Dₐ sets, it is likely that the cluster will be annotated with a category-value pair that is not yet in A_{D}. When no documents have previously been annotated, all clusters to be scored have a likelihood of 1, that is: the annotation will be novel.

Accordingly, at step 315, a next group of documents Dₐ is selected, with a similarity metric σ between the group of documents Dₐ and the cluster C being determined at step 320. This can be determined in any one of a number of manners and may therefore examine the content of the documents, other document properties such as the time at which the documents were created, or the like. For example, in a photo collection, photos may be compared by using feature similarity metrics such as colour histogram intersections.

In this example, the similarity metric σ has a value between 0 (documents have nothing in common according to the features employed) and 1 (the sets of documents are the same according to the features employed). As a result, the value of the similarity metric σ can be used as an indication of the probability of the cluster C and documents Dₐ having the same category-value pair a.

At step 325 a current annotation effect CAE representative of the effect of the cluster C being annotated with the annotation a to form a cluster Cₐ is determined. At step 330 it is determined if all annotated documents Dₐ have been considered and if not the process returns to step 315 to select a next group of documents have a different category-pair value a.

This is repeated until the cluster C has been compared to groups of documents Dₐ for all of the category-pair values a, such that the CAE is given by:

$$CAE ( C , D ) = {\sum }_{a ∈ {A}_{D}} σ ( C , {D}_{a} ) \cdot ( AnnotationCoverage ( D \text{\vert} {C}_{a} , a ∈ {A}_{D} ) ) - AnnotationCoverage ( D ) ) \qquad ( 8 )$$

At this point the process moves on to step 335 with the computer system 200 operating to determine the documents Dₐ for which the similarity metric a has the highest value.

Once this has been determined the computer system 200 determines an added annotation effect AAE representative of the effect of the cluster C being annotated with a new annotation b. In this case, the AAE is given by:

$$AAE ( C , D ) = ( 1 - {max}_{a ∈ {A}_{D}} σ ( C , {D}_{a} ) ) \cdot ( AnnotationCoverage ( D \text{\vert} {C}_{b} , b ∉ {A}_{D} ) - AnnotationCoverage ( D ) ) \qquad ( 9 )$$

The first computation of annotation coverage handles the case where C is annotated with a novel category-value pair, b, while the second computation of AnnotationCoverage handles the case where C is not yet annotated with b.

In the above calculations it is possible that the resulting annotation impact will have a negative value. In one example, a limit value of 0 is applied to the annotation impact so that adding a category-value pair never has a negative impact. However, in this example, measures may be negative, as it indicates that annotation of the cluster may result in the category-value pair losing its effectiveness and discriminative power.

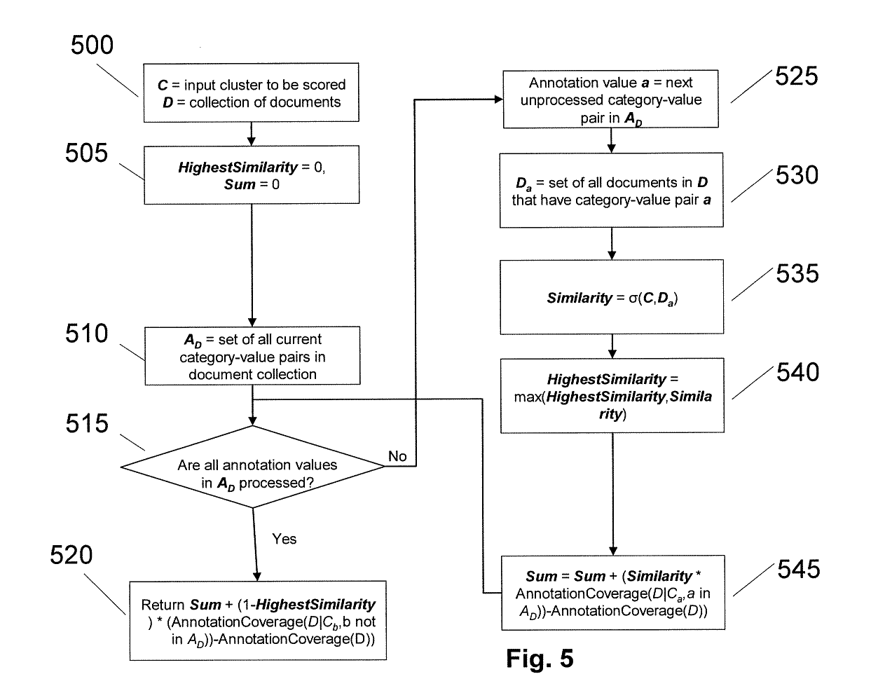

The algorithm used by the computer system 200 is determining CAE and AAE will now described in more detail, with reference to FIG. 5. In this example, A_{D} is the set of all annotations found in the collection 510. For each category-value pair a of A_{D} 515, 525, a group of documents Dₐ is created at 530, comprising all documents that have previously been annotated with annotation a. The cluster C to be scored, input at 500 is compared with each group Dₐ at 535 employing the similarity metric σ which takes as input two sets of documents and gives a similarity score between 0 and 1 as output.

In the example of colour photo images, σ is the intersection of normalized three dimensional RGB colour histogram similarity metric for images with 8 bins in each of the three dimensions. If some documents in C have already been annotated, σ may take those into account, e.g. returning 1 if a document has category-value pair a. If category-value pairs are similar but not the same, σ may return a value of document similarity weighted by a measure of the category-value pair similarity.

In this example, the CAE measure is computed by increasing the sum at 505 with the multiplication of similarity score σ(C, Dₐ) (representing the probability that C has category-value pair a) with the expected change in annotation coverage at 545. The sum is increased for each a in A_{D}. Added to the sum is the computation for the AAE measure: 1 minus the highest similarity at 505 for σ(C, Gₐ) found for an category value-pair a in A at 540 (representing the probability that the category-value pair for C cannot be found in A) multiplied by the expected change in annotation coverage at 520.

FIG. 6 illustrates a further example for calculating the annotation impact.

In this example, a document collection 600 contains 40 documents 610. Six documents are in a first cluster to be scored C₁ 620. Some documents in the collection have been annotated previously, viz. D_{A={x,y}} comprising ₃ documents with category-value pair “A={x,y}” 630 and D_{B={u,v}} comprising 6 documents with category-value pair “B={u,v}” 640.

First, the computer system 200 computes a similarity metric σ=0.6 of C₁ with D_{A={x,y}} at 650. Then the difference between annotation coverage after and before annotating with “A={x,y}” in the preferred embodiment is computed. The increase of the sum at 545 then is 0.062. This means there is a relatively low probability that the cluster to be scored has category-value pair “A={x,y}”, but that even though there are documents already annotated with “A={x,y}”, category-value pair of C₁ with “A={x,y}” will still contribute to the annotation coverage.

Next, the method computes a similarity metric σ=0.9 of C₁ with D_{B={u,v}} at 650. After computing expected change in annotation coverage, the increase of the sum at 545 is computed as −0.015. This means there is a relatively high probability that C₁ has category-value pair “B={u,v}”, but that there are many documents already annotated with “B={u,v}” so that annotating C₁ with “B={u,v}” will actually reduce effectiveness.

Next, the probability of a new category-value pair is based on the highest similarity at 505 of C₁ to the annotated groups 630, 640 and it is multiplied by the expected change in annotation coverage for a novel category-value pair: (1−max(0.6,0.9)) * 0.15=0.015.

This means it is not very likely that a new category-value pair will be entered, but taking into account the size of C₁, all documents would contribute maximally to annotation coverage of the collection if it were to be annotated.

The impact of a new category-value pair weighed by the probability of a new category-value pair then is added to the sum, so that the resulting annotation impact at 520 is 0.062 for the first cluster C₁ 620 to be scored.

Similarly, the annotation impact for the 5 documents in the second cluster to be scored C₂ 625 may be computed. This results in a value of 0.109. Even though C₂ 625 contains less documents than C₁ 620, it does get a higher score because it is expected that the category-value pairs for C₂ 625 are more useful (that is, more novel and more effective) than for C₁ 620.

Whilst the annotation impact alone can be used to determine the annotation again, additional factors may also be calculated.

In the current example, the annotation impact is based on annotations propagating to all documents in a cluster. However, particularly in cases where the user provides an annotation after viewing only the cluster summary, the propagation of the annotation to unseen documents in the cluster may not work well. In those cases, the user may elect to have the annotations propagated to part of a cluster only.

Therefore, in this example, the expected change in annotation coverage is not only based on the annotation impact but is also based on the propagation confidence measure, which measures whether documents in the cluster are expected to have the same or similar category-value pairs.

When the input clusters are user defined, it is expected that the documents in a cluster have at least one meaningful category-value pair in common. The propagation confidence can therefore be set to a maximum value of 1. However, in a more practical scenario where clusters are computed automatically, the annotation system needs to cope with cluster errors.

If the clustering method employed computes and returns a confidence score for each found cluster, the confidence score can be used as the value for the propagation confidence measure, normalized if necessary. This may be obtained from document or cluster metadata, depending on the implementation.

If the clustering method does not compute a confidence score, or if it is a third party method that does not make the information available, or if the confidence score provided by the clustering method is deemed unreliable, a value for the propagation confidence measure needs to be computed.

In one example, the propagation confidence score is at least partially based on the similarity between documents in the cluster. Accordingly, at step 350 the computer system 200 determines a similarity score a (d₁, d₂) for each document pair d₁, d₂ in the cluster C.

For example, the similarity score σ (d₁, d₂) may be based on colour histogram intersection of photos in a cluster. In another example, the similarity may be based on the appearance of the same face in photos in a cluster. In yet another example, the similarity may be based on the number of words all text documents have in common. If all documents are highly similar to one another, there is a high probability that they have a category-value pair in common. If the documents are not that similar to one another, there is a low probability that they have a category-value pair in common.

The similarity score σ (d₁, d₂) is then used to determine a propagation confidence score indicative of the likelihood of an annotation being applied successfully to all documents in the cluster. In this example, the propagation confidence score is computed at step 350 by taking the average of the similarity scores of all possible pairs of documents in the cluster:

$$propagation confidence ( C ) = \frac{{\sum }_{{{d}_{1} ∈ C}_{{d}_{1} \neq {d}_{2}} , {d}_{2} ∈ C} σ ( {d}_{1} , {d}_{2} )}{\vert C \vert \cdot ( \vert C \vert - 1 )} \qquad ( 10 )$$

In an alternative example, the propagation confidence score is computed by taking the lowest similarity score found amongst the similarity scores of all possible pairs of documents in the cluster.

The propagation confidence score may be affected by user interaction. For example, if a user modifies the automatically generated clusters because of an error in the clustering or because the user interprets the documents differently, the modification increases the propagation confidence as user modifications are expected to increase the quality of the clustering.

For example, the propagation confidence may be set to the maximum, such as 1, when it is expected that the user changes everything to be correct. In another example, the propagation confidence may be adjusted to reflect the case where the user improved the clustering, but did not yet make all necessary changes. For example, if document d₁ is moved from cluster A to cluster B, the similarity score between documents already in B and the new member d₁ is set to 1, thereby increasing the average of the similarity scores for B and thereby increasing the propagation confidence score.

Once the propagation confidence is calculated, at step 360 the computer system 200 determines the expected change in annotation coverage using the annotation impact and the propagation confidence. In one example, the expected change in annotation coverage is the propagation confidence score multiplied by the annotation impact. In a second example, the propagation confidence score and the annotation impact are normalized first, for example based on the value ranges.

As described before, the annotation gain may not only be based on a system aspect, but on a user interest aspect as well. In this example, user interest for a cluster is based on monitoring user interaction with documents in the cluster. The monitoring may be done in the context of an application that the annotation recommendation scoring method is part of, and/or it may be done by one or more other applications such as a viewer, browser or editor of the documents. The monitoring may be done real-time, or it may be done via analysis of user interaction logs. Examples of monitored user interaction with a document are: editing, viewing, printing, e-mailing, linking to, and publishing on a Web site.

Accordingly, at step 365 a user interest score E is optionally determined for the cluster C to determine the likelihood of the user being interested in the results of annotating the cluster C. This process will be described in more detail below.

The user interest score is then used together with the annotation coverage change to determine an annotation gain for the cluster C at step 370. In this example, a value for the annotation gain measure based on both the system aspect and the user interest is computed by the weighted sum of the expected change in annotation coverage and the score for user interest.

At step 375 it is determined if all clusters have been considered and if not the process returns to step 310 to select a next cluster.

The clusters for which annotation gains are computed may be part of a hierarchy, in which case the annotation gain can be computed for each individual cluster and sub-cluster.

For example, if cluster A contains sub-clusters B and C, sub-cluster B contains documents d1 and d2, and sub-cluster C documents d3 and d4, then three annotation gains are computed: for A (based on documents d1, d2, d3, and d4), for B (based on documents d1 and d2), and for C (based on documents d3 and d4).

In an alternative example, the annotation gain for a parent cluster may be based on the annotation gain of the child clusters, for example for computational speed-up. In the example, the annotation gain for cluster A may be the average, minimum or maximum of the annotation gains for clusters B and C.

Once all clusters have been considered at step 380, the computer system 200 selects one or more clusters C based on the calculated annotation gain, for example, by selecting the cluster C with the highest annotation gain, or the clusters having an annotation gain exceeding a threshold. The computer system uses this to generate an annotation recommendation indicative of the selected cluster C at step 385, which is displayed to the user at step 390.

At step 395 the user provides an annotation using a suitable input mechanism, with the annotation being duplicated or linked to each of the documents in the cluster C. The process can then return to step 305 to allow further annotations to be received.

Annotation Level

The annotation level is a characterisation of the quantity and/or the quality of the annotations that have been added to a cluster of documents. Each cluster records the level of annotation, and the level may or may not be displayed to the user.

In one example, an annotation level indicator is used to indicate the quality of annotations based on the usefulness of the collected annotations to applications that may potentially use them.

For instance, a photo browser and an application for arranging photos in albums may each have different requirements in terms of annotation. Typically, a photo browser might only fetch annotations based on “people” and “location”, even though the retrieval system supplied with the photo browser is able to address a larger range of annotation categories (e.g. “events”, “item”, “actions”, “comments”, etc).

Alternatively, the annotation level is indicative of the quantity of collected annotations based on the amount of annotation work a user has done on the cluster of documents. Thus, in this case, the annotation level attempts to provide the user with a positive feedback on his effort, thereby encouraging further annotation.

It will be appreciated that in this case, even though a user's annotations may not result in any improvement in accessibility, the annotation level may still show progress so that the user has the feeling their annotation actions are appreciated, until a maximum has been reached.

The process works particularly well as an interactive system, in which the annotation level is computed iteratively. The user may enter several annotations for several clusters in one session, or the user may continue annotating in more than one session, or several users may contribute annotations in several sessions, with the annotation level being recomputed when the annotation of one or more documents in the collection have changed. This can occur, for example because the user adds or removes a category-value pair, or because a third party has provided a duplicate of a document in the collection with annotations associated by the third party.

The annotation level may also be recomputed when user interest for one or more documents in the collection has changed, for example because of editing or browsing of the documents. The annotation level may also be recomputed following a change in cluster configuration, such as when one or more clusters have changed or been recomputed, for example to add, remove or combine clusters. Similarly, the annotation level may be recomputed when cluster membership is changed, such as when documents are added to or removed from clusters, or moved from one cluster to another cluster. The annotation level can also be recomputed when documents are added to or removed from the collection.

GUI

The GUI can be used as an interface to allow indicators to be displayed, for example to assist users in performing annotations. In general, the interface would display at least one cluster representation indicative of a cluster of documents within the collection and at least one indicator indicative of either an annotation level associated with the at least one cluster, a recommendation of annotations to be performed or a confidence score indicative of the confidence in the annotations applied to documents in the cluster.

This allows the effect of each annotation the user makes can be clearly indicated through visual changes to an annotation level indicator provided as part of the GUI presented by the computer system 200, thereby motivating the user to make more annotations. This can also be used to display a recommendation as to which cluster should be annotated next, thereby further helping to improve the annotation procedure.

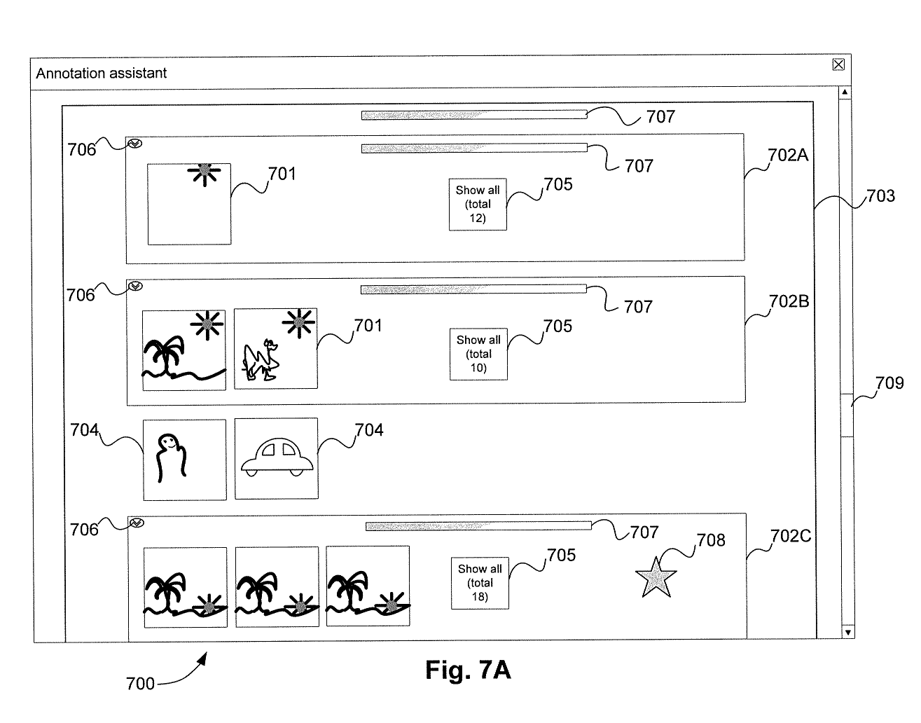

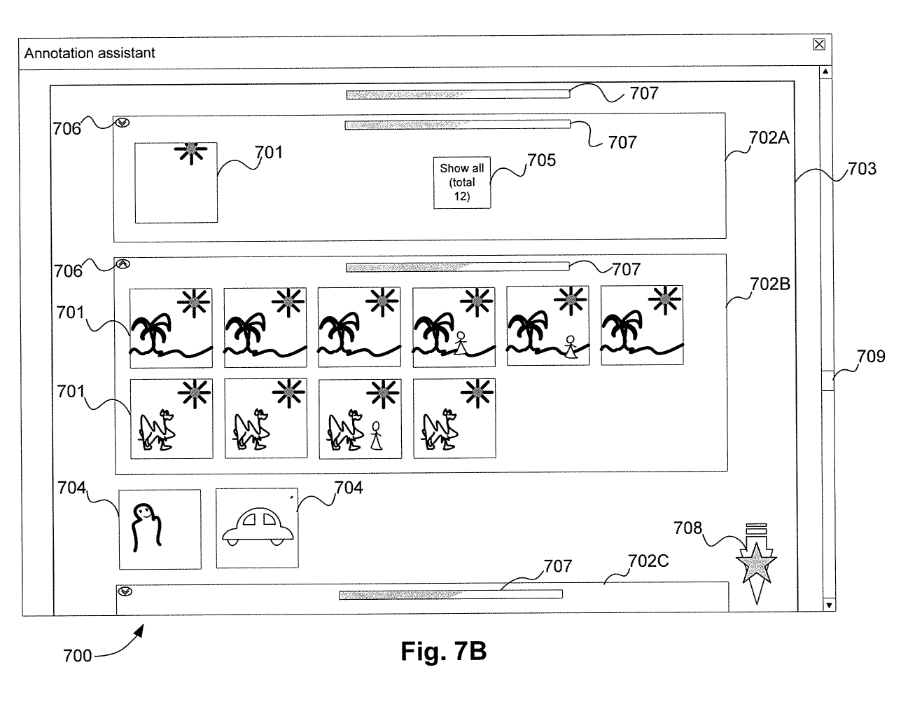

In general, the representation will also show the clusters, any cluster structure, such as relationships between clusters in a cluster hierarchy above. The representation may use cluster summaries, as described above, and typically includes an indication of any existing annotations. An example representation is shown in FIGS. 7A and 7B.

In this example, the GUI 700 displays a number of documents 701 arranged as thumbnails within sub-clusters 702A, 702B, 702C, which are in turn provided within a parent cluster 703. A number of documents 704 are also provided directly within the parent cluster 703 as shown.

Accordingly, a visual link is provided between a parent cluster 703 and its child clusters 702, which in this example is represented by the fact that the child clusters 702A, 702B, 702C, are displayed visually overlayed on the parent cluster 703 in a given order. In this example, the clusters are listed vertically, each on a separate line, although this will depend on the preferred implementation.

In the event that the contents of a cluster are presented as a summary by showing only some of the documents 701, and hiding other documents within the cluster, this is represented by a show/all button 705 presented beside the cluster summary. Hidden documents can be viewed by maximising the cluster, either by clicking the show/all button 705, or by using a minimise/maximise control 706 displayed on each cluster.

FIG. 7B shows a view of the GUI 700 in which the cluster 702B is maximised. In this example, when a cluster is opened, it extends in a vertical direction, using as much space as required to show all documents at a specified thumbnail size. A cluster may be minimised by clicking on the minimise/maximise control 706. This again displays only the cluster summary documents 701 and the summary button 705, hiding all other documents.

It will be appreciated that the GUI 700 visually represents the relationship between clusters 703 and their sub-clusters 702 based on the relative arrangement. This allows users to alter the clustering of documents if this is not suitable by moving documents between clusters, or creating new clusters into which they may move documents. When new clusters are added, these are sorted to their appropriate position in the collection. For clusters of digital images, this can be achieved by sorting in time order based on the shooting date of the first image.

An annotation recommendation is provided shown generally as an icon at 708. In this example, if the cluster 702C is recommended as the preferred cluster for annotation. If the cluster 702C is displayed on the GUI, then the annotation recommendation can be shown in the form of a star, or other icon, presented within the cluster 702C. In the event that the recommended cluster is not presented on the GUI, for example if it has been displaced due to the expansion of another cluster 702B, as shown in FIG. 7B, then the annotation recommendation 708 includes a directional arrow indicating the direction of the recommended cluster 702C. Additionally or alternatively, the icon 708 may be displayed at the top or bottom of the GUI to indicate whether the recommended cluster is located above or below the currently viewed clusters. This allows the user to scroll the GUI 700 in the direction of the directional arrow, for example, by using a scroll bar 709, until the recommended cluster is displayed.

If the user scrolls the GUI 700, the icon 708B moves in the scrolled direction so that it remains in its position until the recommended cluster 702C is shown, at which point the icon 708B will be replaced by the icon 708, shown in FIG. 7A.

The icon 708 can also be used to provide interactivity. Thus, for example in FIG. 7B, if the icon 708 is selected, this can cause the cluster 702C to be annotated to be displayed, as well as optionally opening an annotation dialogue box as will be described in more detail below. The computer system 200 may also automatically adjust the GUI 700 to ensure the recommended cluster 702C is displayed. This can be achieved, for example, by scrolling the GUI 700, or minimising representations of other clusters 702A, 702B.

In an alternative example, the computer system 200 may select the recommended cluster from clusters that are currently viewable on the GUI 700. In this example, as the GUI 700 is manipulated, for example, when the user scrolls the view, or opens and closes clusters, a new cluster may be recommended based on the recommendation scores of the displayed clusters. This allows the user to annotate the cluster deemed most suitable for annotation in their current view.

In a further example, the recommended cluster can be selected from a list of only those clusters that the user has placed in a selection set (by selecting particular clusters from a collection), or by omitting clusters placed on a filter list.

If the recommended cluster is a sub-cluster of a parent cluster that is currently minimised, the computer system 200 can be adapted to automatically open and display the correct child cluster. Alternatively, the computer system 200 can simply recommend the parent cluster initially, with the child cluster being recommended once the user opens the parent cluster.

Alternatively, the appearance of user interface controls (such as the button that maximises a cluster that is currently minimised) can be changed to draw the user's attention to the fact that the parent cluster should be opened, so that the recommendation of the child cluster can be displayed.

The user can then elect to provide an annotation via a suitable mechanism, such as selecting a menu option, selecting the recommendation icon 708, or double-clicking on the cluster to be annotated.

To encourage the user to make more annotations, feedback can also be provided on the representations through an indication of the above-mentioned annotation level. This provides users of an indication of the effect of previous user actions, giving the user the sense that the user is making progress, thereby maintaining enthusiasm to annotate more documents.

In this example, an annotation level of the sub-clusters 702 and the parent cluster 703, is represented by a progress bar 707, as shown, although additional or alternative representations, such as numerical or percentage values, can be used. The annotation level represents a current level of annotation coverage provided by the user, and accordingly, as annotations are provided, the computer system 200 updates the progress bar 707, to reflect the new annotation coverage.

Typically however the exact numerical value of the annotation level is not represented to the user, as the purpose is merely to provide the user positive reinforcement, and encourage them to continue making annotations.

To support further reinforce this, the computer system 200 can be adapted to only show increases in annotation level, with the progress bar remaining unchanged in the event that the annotation level decreases. This helps the user sense that progress is being made, thereby maintaining enthusiasm to annotate more documents.

Similarly, to further reinforce the concept that increases in annotation level are intended to reward the user for making annotations, the progress bar or other indication may be shown only when a certain annotation level has been reached.

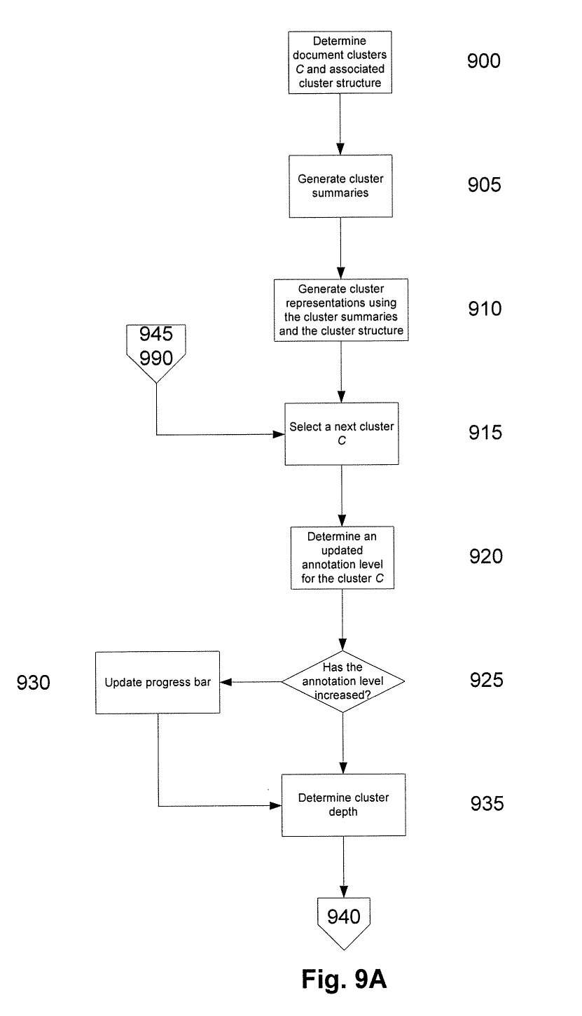

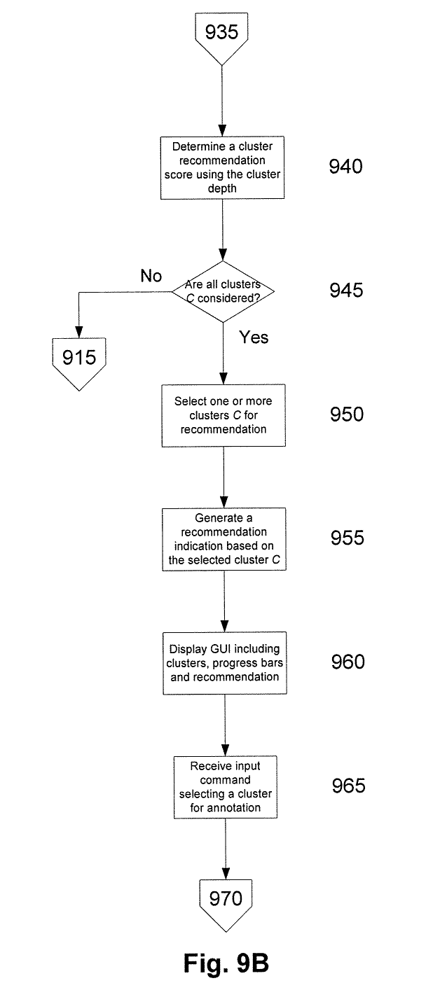

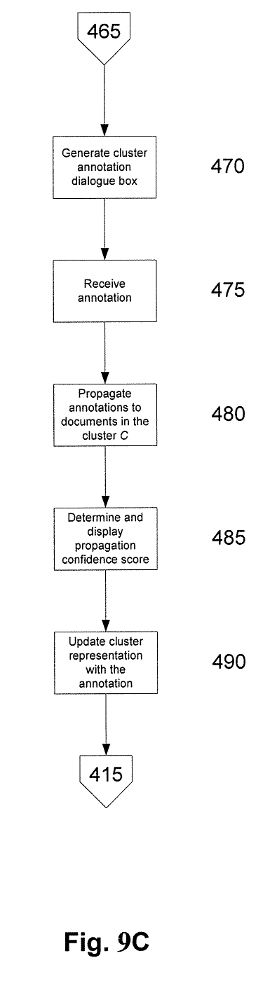

The manner in which the GUI is generated and updated will now be described in more detail will respect to FIGS. 9A to 9C.

At step 900 the computer system 200 determines a number of document clusters C and an associated cluster hierarchy, or other structure. This may be achieved based on pre-defined cluster structures stored in the memory 206, or determined through the use of appropriate clustering algorithms, or the like, as described above.

The computer system 200 then determines cluster summaries for each of the clusters as required. The cluster summaries may be predetermined and are, in any event, typically be context dependent, being influenced by factors such as defined thumbnail sizes, screen resolution, number of clusters to be displayed, or the like. Accordingly, at step 905, the computer system assesses each of the relevant factors and generates an appropriate cluster summary, which in this example, involves selecting a predetermined number of images for presentation for each cluster C.

It should be noted that a cluster summary may be identical to the cluster, in which case, at step 905 the computer system 200 will simply return the content of the cluster as the cluster summary.

At step 910, the computer system generates representations for the clusters and cluster summaries, which are displayed to the user on the display 214 using the GUI 700 described above, in a later step 960.

At step 915 the computer system 200 selects a next cluster C and determines an annotation level for the cluster at step 920. The annotation level can be calculated using a number of methods.

For example, when performing a qualitative assessment of the annotation level, denoting {k₁, . . . , k_{n}} the set of categories that are relevant to an application and {w₁, . . . , w_{n}} a list of coefficients used for weighting the effect of each category in the computation. The annotation level can be computed based on the discriminative power of annotations as follows:

$$AnnotationLevel ( C ) = {\sum }_{i = 1}^{n} {\sum }_{{a ∈ {A}_{C}}_{category ( a ) = {k}_{i}}} {w}_{i} disc\_pow ( a , D ) , \qquad ( 11 )$$

where:

$$disc\_pow ( a , D ) = \frac{1}{\vert {D}_{a} \vert} , \qquad ( 12 )$$

A_{c} is the set of category-value pairs in the annotation of cluster C
   |Dₐ| is the number of documents in collection D having annotation a.

However, as an alternative, a quantitative assessment can be performed in which the annotation level of a cluster is maximal when, for each available category, at least one value has been defined for all documents in the cluster.

In this example, K is the set of categories used in the annotation system, for example “event”, “person” and “location”. Let Vₖ(d) be the set of values annotated for a category k on a document d, for example {“John”, “Peter”} for k=“person”. Let the || operator denote the number of elements in a set. Accordingly, in this instance, the annotation level of a cluster C is:

$$AnnotationLevel ( C \text{\vert} K ) = \frac{{\sum }_{d ∈ C , k ∈ K} min ( 1 , \vert {V}_{k} ( d ) \vert )}{\vert C \vert \cdot \vert K \vert} \qquad ( 13 )$$

Whilst the annotation level can be defined linearly, in general it is preferred to define a non-linear term so that initial annotations are rewarded more than later annotations. This is performed for two main reasons.

Firstly, in general, annotating documents that are not annotated at all is more valuable than annotating documents that already have been annotated. Secondly, feedback to the user should be clearer in an earlier stage, when the user may still need to be convinced to put effort into annotating. Thus, it is expected that once a larger amount of annotation has been completed, the user will have enough motivation to continue.

Therefore, in this example, non-linear scaling is employed to compute the annotation level, which results in modification of equation (13) as follows:

$$AnnotationLevel ( C \text{\vert} K ) = \sqrt[r]{\frac{ {\sum }_{d ∈ D , k ∈ K} min ( 1 , \vert {V}_{k} ( d ) \vert ) }{\vert C \vert \cdot \vert K \vert}} \qquad ( 14 )$$

where: r is a predefined value greater than 1, such as 2.

Once the annotation level is determined, this can be used to update the progress bar representation 707.

As described above, it is typically undesirable for the progress bar to decrease in size as this could discourage users. Accordingly, at step 925 it is determined if the annotation level has increased, and if so, the computer system 200 updates the progress bar 707 at step 930, by increasing the progress bar fill to reflect the new annotation level, with the process then moving on to step 935.

As part of this, it will be appreciated that if the progress bar 707 was previously full, indicating that the corresponding cluster is suitably annotated, this does not necessarily prevent the user adding further annotations. In this instance, the progress bar will remain filled.

Whilst decreases in annotation level caused by adding annotations that do not assist in distinguishing documents are usually not indicated, it may be desirable to indicate decreases in annotation level in some case. This may be required, for example, if the user removes annotations from a cluster, or when new documents are added to the cluster. In this instance, if the annotation level decreases, the computer system can perform an addition check to determine if annotations are removed, or documents added, before determining whether or not to update the progress bar at step 930.

Since annotations are propagated from parent to child clusters, a change in the annotation level of a parent cluster may also have an automatic effect on the annotation level of each child due to this association. Accordingly, when calculating change in annotation level, the computer system 200 may have to recompute the annotation level of all the descendant clusters and ancestor clusters of the cluster whose annotation has been changed. Depending on the equation used for computing the annotation level, in some examples, annotation levels of all the clusters have to be recomputed.

At step 945 it is assessed whether all the clusters are considered and if not the process returns to step 915 to update the progress bar and determine a cluster recommendation score for the next cluster.

Once this has been completed for each cluster, the process moves on to step 450 to select one or more clusters C for recommendation. At least one cluster may be recommended to the user, but more than one may also be recommended, depending on the preferred implementation. This can be achieved for example by selecting one or more of the clusters C having the highest scores, or alternatively, by selecting any clusters C having a score greater than a predetermined threshold.

In either case, at step 955, the computer system 200 generates a recommendation representation, such as the recommendation icon 708 previously described. Finally, at step 965 the computer system 200 receives an input command from a user selecting a cluster for annotation. This may be achieved in any one of a number of ways, such as using an input device 202, 203, selecting an appropriate menu option, or using a cluster annotation dialogue box or the like.

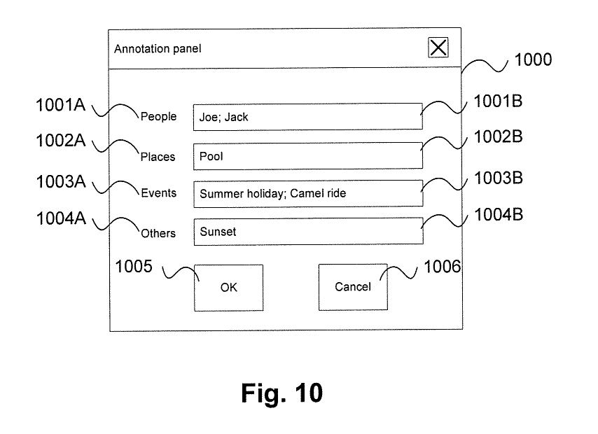

An example cluster annotation dialogue box is shown in FIG. 10. As shown the dialogue box 1000 includes a number of input fields 1001B, 1002B, 1003B, 1004B, each of which is associated with a respective category 1001A, 1002A, 1003A, 1004A. This allows a user to input a category-value pair simply by entering values in respective ones of the fields 1001B, 1002B, 1003B, 1004B. Once the annotation is completed, the user can select an “OK” button 1005 to complete the annotation, or a “Cancel” button 1006 to cancel the annotation.

When the user adds annotations, they can freely add values (such as “Paris”) to any category (e.g “Location”). However, if the user chooses to add multiple annotations to the same category, these annotations may not be as useful with respect to the overall annotation quality than annotations that are spread over multiple categories. In order to help the user annotate their collection in the most effective and diverse manner, specific categories of annotation may be recommended over others if they are yet to receive annotations for a given cluster. In one example, changes in colour intensity of the category name or fields can be used to indicate which categories should be preferably annotated.

Similarly, it may be more useful for the user to add a variety of different values to a pre-selected set of documents and/or clusters in the collection, rather than repeatedly apply the same value on different clusters. To achieve this diversity in values, specific values that have been used regularly in the collection may be reduced in importance in the user interface. In the preferred embodiment, given a user interface that allows previously entered values to be re-selected from a drop-down list, these often used values would be relegated to lower positions in the list to discourage repeated use.

In order to annotate individual documents, the user may select the documents on the GUI 700 and select an annotation option, causing the annotation dialogue box to be displayed, but with the computer system 200 ensuring that consequent annotations are only applied to selected documents.

At step 975 the computer system receives the completed annotations, and propagates these to the documents in the selected cluster at step 980. This can be achieved in a number of ways, such as by duplication or reference, as described above.

As mentioned above, in the event that only a portion of the documents in the cluster are displayed as part of the cluster summary, annotations propagated to the remaining documents may be less relevant than intended. This can be accounted for by marking the annotations as implicit or explicit as described above, or by calculating a propagation confidence score, which measures whether documents in the cluster are expected to have the same or similar category-value pairs.

Once this has been completed the representation of the cluster can be updated at step 990 reflecting the supplied annotation. The process then returns to step 915, to allow the annotation level and consequently the progress bar 707 to be updated, and a new recommendation to be made.

Accordingly, as the user makes changes to annotations, clusters, or the like, the recommendation score and annotation levels can be continually updated. Thus, for example, once the cluster that is recommended changes, the icon 708 can be moved to overlay the newly recommended cluster. The user is free to continue annotating any other cluster; the recommendation based on annotation is designed only to indicate where annotation will have the best effect on the overall document accessibility.

However, in order to reduce user frustration and confusion, the cluster that is recommended should not change after small changes (e.g. character by character), and similarly should not change back and forth between two clusters after each small change. To satisfy this requirement, one embodiment involves a threshold of annotation that may be used to ensure that the recommendation can only be re-evaluated after a fixed number of changes have been made. In another example, a GUI control (such as a button) may be used to trigger the application of all annotation changes made since the last time the control was activated. At this point, the recommendation score may be re-calculated and the recommendation icon moved to a new cluster as necessary.

Additionally, once the annotation levels have been revised, the clusters presented on the GUI can be re-ordered, allowing the order to reflect the current annotation level. This allows the user to annotate in order of least amount of work, thereby making changes where they are likely to be needed. In one example, this sorting is performed on each level of a hierarchy of clusters, (e.g., all children clusters of one parent cluster are sorted) so that the user may annotate clusters and documents on each level of the hierarchy based on this value.

A progress bar may also be provided at a top level of the hierarchy, to represent the annotation level of the entire collection. This is treated in the same manner as each cluster, and can therefore be updated whenever an annotation is changed. In one example, the collection progress bar is visually represented using the same method as is used to represent the annotation level for a cluster, with the value being a representation or summary of the values of each cluster in the collection. In another example, the value may be based on the annotations applied to individual documents in the collection.

In such a system, it is preferred that the overall annotation level value will increase even if changes being made are not helpful to the overall document accessibility. This is to ensure the user is not discouraged when it appears that their work is having a negative effect. However, this is not necessary, and the value may decrease in these situations. Also, the overall collection annotation level value may decrease when more documents are added to the collection. This is because more documents without annotation are now present in the collection.

### Alternative Embodiments

The annotation coverage may be determined in any one of a number of ways, and can depend for example on factors such as the cluster's contribution to the overall annotation coverage, or the like.

In an alternative example, the annotation coverage of a cluster C in the context of a collection of documents D using a modified version of equation (5), as follows:

$$AnnotationCoverage ( C , D ) = \frac{{\sum }_{d ∈ C , \vert {A}_{d} \vert > 0} {max}_{a ∈ {A}_{d}} ( effectiveness ( a , D ) )}{\vert C \vert} \cdot efficiency ( C ) \qquad ( 15 )$$

Apart from communicating to the user which clusters are best annotated to maximize annotation gain, this also helps the user to communicate which category-value pairs are best used for annotating the cluster.

For example, in a user interface where the user can select category-value pairs that previously have been associated with other clusters and documents, the list of category-value pairs may be ranked so that the category-value pair resulting in the highest annotation gain when applied to the selected cluster is presented first.

In this example, the computations employed in the CAE measure is reused to score annotations for each category-value pair a in A_{D} given a selected set of documents C in the context of document collection D:
annotation_score(a, C, D)=AnnotationCoverage(D|Cₐ, a∈A_{D})−Annotation Coverage(D)( 16)

Similarly, the score for annotating the selected cluster with a novel category-value pair can be computed.

User Interest

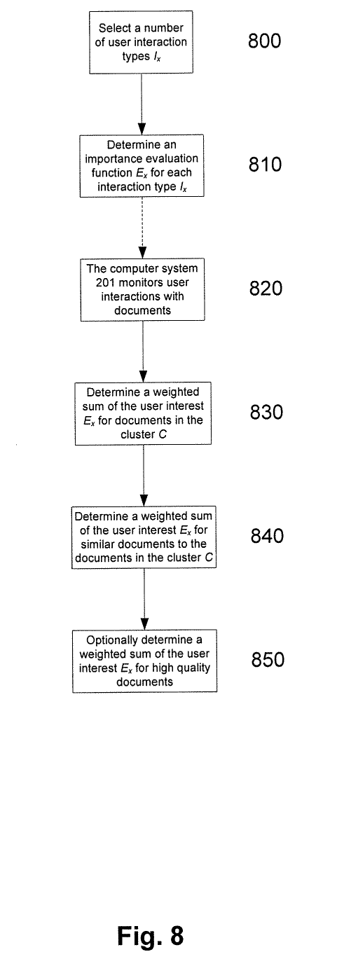

FIG. 8 is an example of a process for determining a user interest for documents in a cluster.

In this example, the user interest is determined by weighing the amount of interactions (such as the number of times documents in the cluster have been viewed) with a measure of the importance of those interactions (such as the number of seconds the document was viewed).

For example, when a user spends one second on viewing a document, it may indicate that the user evaluated the document quickly but that it is not an important document to the user, e.g. a bad image. In another example, a user views a document for ten seconds and edits it, indicating that the document is important to the user and of great interest.

To achieve this, at step 800 a number of user interaction types Iₓ are selected. This can then be achieved for example by allowing a user to manually select various options from a drop s down list, define new interaction types, or alternatively these can be predefined in the software provided on the computer system 200. Example interactions include viewing (I₁), editing (I₂) and printing (I₃) documents.

At step 810 an evaluation importance function Eₓ, is determined for each interaction type. This is used to define the relative importance of the different types of interaction.

At step 820 the computer system 200 monitors user interactions with the documents this will typically be achieved by maintaining a record of user interaction with each document in the document collection. Thus for example, this can be in the form of a database that records information at least partially indicative of the user interactions, such as the number of interactions for each interaction type, for each document. Alternatively, details of the interaction can also be recorded.

For example, if the document was viewed but less than a number of seconds determined by a viewing threshold, say 2, E₁ may return 1.0. If the document was not viewed at all, E₁ may return 0.5. And if the document was viewed for a number of seconds greater than or equal to the viewing threshold, E₁ may return 1.0. For example, E₂ and E₃ may return 1.0 if the user interaction was performed and 0.0 otherwise.

At step 830 the computer system 200 determines the user interest Eₓ for documents in the cluster C based on the number of interactions that have occurred. In this example, the user interest is defined as the sum of the values returned by Eₓ for all documents in the cluster, divided by the number of documents in the cluster. The terms Eₓ are weighted, where the weights represent the importance of user interaction of type x in general and how much a user is willing to spend on a document.

The weights may be factory settings based on heuristics, or they may be set by the user. For example, an edit interaction costs the user more in effort than simply viewing a document, and printing even costs the user in ink and paper. Then the weight for I₁ (viewing) may be set to 0.2, the weight for I₂ (editing) to 0.4, and the weight for I₃ (printing) to 0.6.

At step 840 the computer system 200 may also optionally determine a user interest Eₓ for similar documents in other clusters. This is used to assess the users interest in documents in the cluster by considering not only those documents but also other documents of a similar nature. This may be applied to allow the computer system 200 to determine Eₓ for a limited number of other documents, such as the top 10 most similar documents, all documents having a similarity metric σ higher than a threshold such as 0.9, or the like.

In a further variation, the user interest can also be based on the quality of content of the documents, as shown at step 850. This is performed on the basis that the user is more interested in high quality documents (eg. nice photos or well-written texts) than in bad quality documents. Examples of measuring the quality of a document are analysis of edges in a photo (where weak edges indicate out of focus or motion blur) or analysis of the number of spelling and grammar errors and use of passive voice in a text document.

In a further example, user interest is based on a user profile specified by the user and/or automatically constructed by the system. For example, the user create a user profile stating that he or she is interested only in video segments that last no more than 30 seconds. In another example, the system creates a user profile by observing that the user never watches video segments that last more than 30 seconds.

Application to IDEs

The foregoing embodiment describes a method of acquiring user annotations for databases of digital image documents. The term document includes any electronic document such as text, audio and video documents, CAD designs of buildings and molecules, models of DNA sequences, DNA sequence listings or the like, and in particular includes any multimedia content items, such as photos, video segments, audio segments, or the like.

However, the techniques are also applicable to applications such as Integrated Development Environments (IDE), which allow a programmer to write, compile, edit, test and/or debug source code. Often programmers do not have the time to write comments for all pieces of code. It is important that they focus their commenting efforts on those pieces of code that are most in need of further description.

In this case, the documents consist of declarations of classes, variables, methods, etc. The annotations are text comments that the programmer associated with these declarations to explain and document their purpose. A source code comment may consist of a few lines of text associated with one of the comment fields such as @version, @author, @param, @return, @exception, etc. commonly used for documenting Application Programming Interfaces (APIs). Such source code comments can be equated to category-value pairs of annotations.

During the editing of the source code, an IDE application may recommend the programmer to enter comments for those parts of the source code that appear to be key components of the software. The annotation gain is based on both a measure of the user interest and a measure of the expected change in annotation coverage.

In this scenario, the user interest can be a function of the time the programmer spent on editing, updating and debugging a piece of code while annotation coverage can be computed based on the proportion of source documents that has been annotated (a.k.a extent) and/or on a measure of the number of pieces of source code an annotation is associated with (a.k.a. discriminative power), and/or on the portion of declarations of a source document that has non-empty comment fields (a.k.a efficiency).

In this case, when computing the annotation coverage, the comment of a declaration may also be weighted according to a measure of the importance and/or complexity of the associated code. The importance measure may be based on the number of times the code is referenced or called while the complexity measure may be based on the size of the code and the number of conditional statements it contains.

Throughout the above description the term cluster is understood to refer to any group of one or more documents. Thus, the proposed methods may be applied to single documents, as it is the same as populating each cluster with one document. In this case, the propagation confidence would always be 1 and other measures would be computed as described above.

The term processing system is understood to encompass the computer system 200, as well as any other suitable processing system, such as a set-top box, PDA, mobile phone, or the like.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method for use in annotating documents provided in a collection, the method comprising, in a processing system:
a) determining, for a number of document clusters, an annotation gain, the annotation gain being at least partially indicative of the effect of annotating at least one document associated with the respective cluster;
b) determining a recommendation indicative of at least one cluster in accordance with the determined annotation gains; and,
c) providing an indication of the recommendation.

2. A method according to claim 1, wherein the method comprises, in the processing system, determining the annotation gain for a cluster using at least one of:
a) an expected change in annotation coverage obtained by annotating the cluster; and,
b) a user interest indicative of user interactions with at least one of:
i) documents in the cluster; and,
ii) documents similar to documents in the cluster.

3. A method according to claim 2, wherein the method comprises, in the processing system, determining the annotation coverage using at least two of:
a) a document annotation extent;
b) an annotation discriminative power;
c) an annotation effectiveness; and,
d) an annotation efficiency.

4. A method according to claim 1, wherein the method comprises, in the processing system:
a) determining an annotation impact for a respective cluster by:
i) determining a current annotation effect indicative of the effect of annotating the cluster with existing annotations associated with other documents; and,
ii) determining an added annotation effect indicative of the effect of annotating the cluster with a new annotation; and,
b) using the annotation impact in determining the annotation gain.

5. A method according to claim 4, wherein the method comprises, in the processing system:
a) for at least one group of documents annotated with an existing annotation:
i) determining a similarity metric between documents in the cluster and the documents in the group;
ii) determining an expected annotation coverage obtained if the documents in the cluster are annotated with the existing annotation; and,
b) determining the current annotation coverage of the document collection; and,
c) determining the current annotation effect using the similarity metric, the current annotation coverage and the expected annotation coverage.

6. A method according to claim 4, wherein the method comprises, in a processing system:
a) determining a similarity metric between documents in the cluster and a most similar group of previously annotated documents;
b) determining an expected annotation coverage obtained if the documents in the cluster are annotated with a new annotation; and,
c) determining the current annotation coverage of the document collection; and,
d) determining the added annotation effect using the similarity metric, the current annotation coverage and the expected annotation coverage.

7. A method according to claim 1, wherein the method comprises, in the processing system:
a) determining a confidence score at least partially based on a similarity score determined for each pair of documents in the cluster; and,
b) using the confidence score in determining the annotation gain.

8. A method according to claim 7, wherein the method comprises, in the processing system, determining the confidence score using at least one of:
a) an indication of user interactions with the documents in the cluster; and,
b) metadata associated with the documents in the cluster.

9. A method according to claim 1, wherein the method comprises, in the processing system:
a) monitoring user interactions with documents in the cluster; and,
b) determining a user interest score based using the monitored user interactions.

10. A method according to claim 9, wherein the method comprises, in the processing system:
a) determining a number of interaction types;
b) for each interaction type, determining:
i) a number of user interactions; and,
ii) a relative importance; and,
c) using the determined number of user interactions and the relative importance to determine the user interest score.

11. A method according to claim 10, wherein the user interaction types comprise at least one of:
a) viewing a document;
b) printing a document;
c) editing a document;
d) e-mailing a document;
e) publishing a document; and,
f) linking to a document.

12. A method according to claim 9, wherein the method comprises, in the processing system, determining a user interest score using at least one of:
a) a user profile specified by the user; and,
b) a user profile automatically constructed by the processing system.

13. A method according to claim 1, wherein the method comprises, in the processing system, determining the annotation gain following at least one of:
a) annotation of at least one document;
b) a change in user interest for at least one document;
c) a change in cluster membership, including at least one of:
i) adding a document to a cluster;
ii) removing a document from a cluster; and,
iii) moving a document from one cluster to another cluster;
d) a change in configuration of clusters, including at least one of:
i) adding a cluster;
ii) removing a cluster; and
iii) combining clusters; and,
e) adding a document to the collection; and,
f) removing a document from the collection.

14. A method according to claim 1, wherein the method comprises, in the processing system:
a) determining a cluster summary for at least one cluster;
b) requesting user annotations for the at least one cluster summary;
c) receiving user annotations via an input; and,
d) applying the user annotations to documents in the cluster represented by the cluster summary.

15. A method according to claim 14, wherein the method comprises, in the processing system, applying the user annotations by at least one of:
a) duplicating the user annotations;
b) referencing the user annotations; and,
c) storing at least a portion of the user annotations as metadata associated with the documents.

16. A method according to claim 1, wherein the method comprises, in the processing system, determining clusters using at least one of:
a) a clustering algorithm; and,
b) user input commands received via an input.

17. A method according to claim 1, wherein the method comprises, using annotations comprising at least one of:
a) at least one category-value pair;
b) a confidence score;
c) information used for calculating a confidence score; and
d) an indicator indicative of the means by which an category-value pair was obtained.

18. A method according to claim 1, wherein the document is at least one of:
a) an image; and,
b) a video segment.

19. Apparatus for use in annotating documents provided in a collection, the apparatus including a processing system for:
a) determining, for a number of document clusters, an annotation gain, the annotation gain being at least partially indicative of the effect of annotating at least one document associated with the respective cluster;
b) determining a recommendation indicative of at least one cluster in accordance with the determined annotation gains; and,
c) providing an indication of the recommendation.

20. Apparatus according to claim 19, wherein the processing system comprises at least one of:
a) a store for storing at least one of:
i) documents;
ii) annotations;
iii) references to annotations;
iv) a cluster configuration;
v) cluster summaries;
vi) information at least partially indicative of a confidence score;
vii) information at least partially indicative of user interactions;
b) a display for displaying at least one of:
i) documents;
ii) document clusters;
iii) annotations;
iv) a cluster summary; and,
v) the recommendation; and,
c) an input for receiving at least one of:
i) annotations; and,
ii) user input.

21. A computer program product for use in annotating documents provided in a collection, the computer program product being formed from computer executable code, which when executed on a suitable processing system is for:
a) determining, for a number of document clusters, an annotation gain, the annotation gain being at least partially indicative of the effect of annotating at least one document associated with the respective cluster;
b) determining a recommendation indicative of at least one cluster in accordance with the determined annotation gains; and,
c) providing an indication of the recommendation.

22. A method for use in annotating documents provided in a collection, the method comprising, presenting an interface on a display using a processing system, the interface comprising:
a) at least one cluster representation indicative of a cluster of documents within the collection; and,
b) at least one indicator indicative of at least one of:
i) an annotation level associated with the at least one cluster;
ii) a recommendation of annotations to be performed; and,
iii) a confidence score indicative of the confidence in the annotations applied to documents in the cluster.

23. A method according to claim 22, wherein the method comprises, in the processing system:
a) determining a cluster summary associated with the at least one cluster; and,
b) displaying the cluster summary as part of the cluster representation.

24. A method according to claim 23, wherein the method comprises, in the processing system:
a) displaying an icon associated with the cluster summary;
b) detecting user interaction with the icon; and,
c) expanding the cluster representation to display each document in the cluster in response to the interaction.

25. A method according to claim 22, wherein the method comprises, in the processing system:
a) determining a hierarchy of clusters; and,
b) displaying representations of clusters in accordance with the hierarchy.

26. A method according to claim 25, wherein the method comprises, in the processing system:
a) determining a parent cluster and at least one associated sub-cluster; and,
b) displaying a representation of the at least one sub-cluster within the representation of the parent cluster.

27. A method according to claim 22, wherein the method comprises, in the processing system, displaying the annotation level indicator for a cluster as a progress bar associated with the corresponding cluster representation.

28. A method according to claim 22, wherein the method comprises, in the processing system, determining the annotation level for a cluster based on at least one of:
a) a quantity of annotations associated with the cluster;
b) a quality of annotations associated with the cluster;
c) a discriminative power of annotations associated with the cluster; and,
d) a non-linear scaling.

29. A method according to claim 22, wherein the method comprises, in the processing system,
a) selecting at least one cluster for annotation; and,
b) generating the recommendation indicator based on the at least one selected cluster, so as to recommend a cluster for annotation.

30. A method according to claim 29, wherein the method comprises, in the processing system, displaying the recommendation indicator as an icon, the icon being at least one of:
a) associated with a visible representation of the recommended cluster; and,
b) arranged so as to indicate the position of representation of the recommended cluster that is not currently visible on the display.

31. A method according to claim 30, wherein the method comprises, in the processing system, indicating the position of a recommended cluster by at least one of:
a) a position of the icon on the display; and,
b) a directional arrow.

32. A method according to claim 30, wherein the method comprises, in the processing system:
a) detecting user interaction with the icon; and,
b) modifying the interface to display the recommended cluster in response to the interaction.

33. A method according to claim 29, wherein the method comprises, in the processing system, and in the event that a recommended cluster is a sub-cluster of a parent cluster:
a) using the recommendation indicator to indicate the parent cluster; and,
b) using the recommendation indicator to indicate the sub-cluster when the parent cluster is expanded.

34. A method according to claim 22, wherein the method comprises, in the processing system, determining a confidence score for annotations associated with a document in a cluster based on at least one of:
a) an annotation type;
b) user interactions with the document; and,
c) for an implicit annotation, the similarity of the document with other documents that have an explicit annotation.

35. Apparatus for use in annotating documents provided in a collection, the apparatus comprising a processing system and a display, the processing system being for presenting an interface on the display, the interface comprising:
a) at least one cluster representation indicative of a cluster of documents within the collection; and,
b) at least one indicator indicative of at least one of:
i) an annotation level associated with the at least one cluster;
ii) a recommendation of annotations to be performed; and,
iii) a confidence score indicative of the confidence in the annotations applied to documents in the cluster.

36. Apparatus according to claim 35, wherein the processing system comprises at least one of:
a) a store for storing at least one of:
i) documents;
ii) annotations;
iii) annotation references;
iv) a cluster configuration;
v) cluster summaries;
vi) information at least partially indicative of a confidence score;
vii) information at least partially indicative of user interactions;
b) a display for displaying at least one of:
i) documents;
ii) document clusters;
iii) annotations;
iv) a cluster summary; and,
v) the recommendation; and,
c) an input for receiving at least one of:
i) annotations; and,
ii) user input.

37. A computer program product for use in annotating documents provided in a collection, the computer program product being formed from computer executable code, which when executed on a suitable processing system causes the processing system to present an interface on a display, the interface comprising:
a) at least one cluster representation indicative of a cluster of documents within the collection; and,
b) at least one indicator indicative of at least one of:
i) an annotation level associated with the at least one cluster;
ii) a recommendation of annotations to be performed; and,
iii) a confidence score indicative of the confidence in the annotations applied to documents in the cluster.
